(19) United States
(12) Patent Application Publication
(10) Pub. No.: US 2003/0144618 A1
(43) Pub. Date: Jul. 31, 2003

(54) Back scratching device

(76) Inventors: Douglas D. Harmon, Heber City, UT (US); Jon A. Warner, Santa Barbara, CA (US)

Correspondence Address: Kolisch, Hartwell, Dickinson,, McCormack & Heuser, PC, Suite 200, 520 S.W. Yamhill Street, Portland, OR, 97204, US

(21) Appl. No.: 10/057,611

(22) Filed: Jan. 25, 2002

(51) Int. Cl. A61H 7/00

(52) U.S. Cl. 601/136

(57) ABSTRACT

A back scratching device. The device includes a body having a core and an abrasive contact surface. The body is removably or permanently coupled to a frame by an attachment structure. In some embodiments, the core may be at least substantially formed from a closed-cell material. In some embodiments, the abrasive contact surface is defined by a plurality of fragmented cells and/or surface structures. In some embodiments, the core and/or the contact surface includes a plurality of layers of variable densities and/or impregnated abrasive materials. In some embodiments, the body may be at least generally shaped to correspond to the anatomical regions of the spine. In some embodiments, the vertical dimensions of the body substantially exceed the horizontal dimensions of the body.

### FIELD OF THE INVENTION

The present invention is directed to personal care devices, and more particularly, to a back scratching and cleansing device.

### BACKGROUND OF THE INVENTION

A variety of back scratching and cleansing devices are known in the art. Examples of these devices include manually positioned devices that are used to reach portions of a user's back that otherwise are difficult to effectively reach. Other examples include devices that are mounted on a wall and which are used by a user manually positioning the user's back relative to the device.

### SUMMARY OF THE INVENTION

The present invention provides an improved back scratching device. The device includes a body having a core and an abrasive contact surface. In some embodiments, the core may be at least substantially formed from a closed cell material, such as polyethylene. In some embodiments, the abrasive contact surface is defined by a plurality of fragmented cells and/or surface structures. In some embodiments, the core and/or the contact surface may include a plurality of layers of variable densities and/or impregnated abrasive materials. In some embodiments, the body may be at least generally shaped to correspond to the anatomical regions of the spine. In some embodiments, the vertical dimensions of the body substantially exceed the horizontal dimensions of the body. The device further includes a frame adapted to support the body and an attachment structure coupled to the frame and adapted to mount the device on a wall surface. In some embodiments, the body may be adapted to be selectively detached from and reattached to the frame. In other embodiments, the body is integrally formed with or otherwise permanently secured to the frame.

### BRIEF DESCRIPTION OF THE DRAWINGS

FIG. 1 is an isometric view of a back scratching and cleansing device having a body and a frame constructed in accordance with the present invention and mounted on a wall surface.

FIG. 2 is a front elevation view of the body of the back scratching and cleansing device shown in FIG. 1.

FIG. 3 is a side elevation view of the body of the back scratching and cleansing device shown in FIG. 1.

FIG. 4 is a top plan view of the back scratching and cleansing device shown in FIG. 1 mounted on a wall surface and being used to cleanse and/or scratch a user's back, which is schematically illustrated.

FIG. 5 is a cross-sectional view of a body for the device shown in FIG. 1.

FIG. 6 is a cross-sectional view of another body for the device shown in FIG. 1.

FIG. 7 is a cross-sectional view of another body for the device shown in FIG. 1.

FIG. 8 is a cross-sectional view of another body for the device shown in FIG. 1.

FIG. 9 is a cross-sectional view of another body for the device shown in FIG. 1.

FIG. 10 is a cross-sectional view of another core for the device shown in FIG. 1.

FIG. 11 is a cross-sectional view of another back scratching and cleansing device constructed in accordance with the present invention.

FIG. 12 is an isometric view of another back scratching and cleansing device constructed in accordance with the present invention and having a selectively detachable body and a frame.

FIG. 13 is a front elevation view of the frame shown in FIG. 12.

FIG. 14 is a cross-sectional view of the back scratching and cleansing device shown in FIG. 12.

FIG. 15 is a cross-sectional view of another back scratching and cleansing device constructed in accordance with the present invention.

FIG. 16 is cross-sectional view of another back scratching and cleansing device constructed in accordance with the present invention.

FIG. 17 is a side elevation view of the back scratching and cleansing device shown in FIG. 12 showing the adjustability of the body within the frame.

FIG. 18 is an isometric view of another body for a back scratching and cleansing device constructed in accordance with the present invention.

FIG. 19 is a fragmentary bottom plan view of the body shown in FIG. 18.

FIG. 20 is a fragmentary side elevation view of the body shown in FIG. 19.

FIG. 21 is a fragmentary bottom plan view of another body constructed in accordance with the present invention.

FIG. 22 is a fragmentary side elevation view of the body shown in FIG. 21.

FIG. 23 is a fragmentary bottom plan view of another body constructed in accordance with the present invention.

FIG. 24 is a fragmentary side elevation view of the body shown in FIG. 23.

### DETAILED DESCRIPTION AND BEST MODE OF THE INVENTION

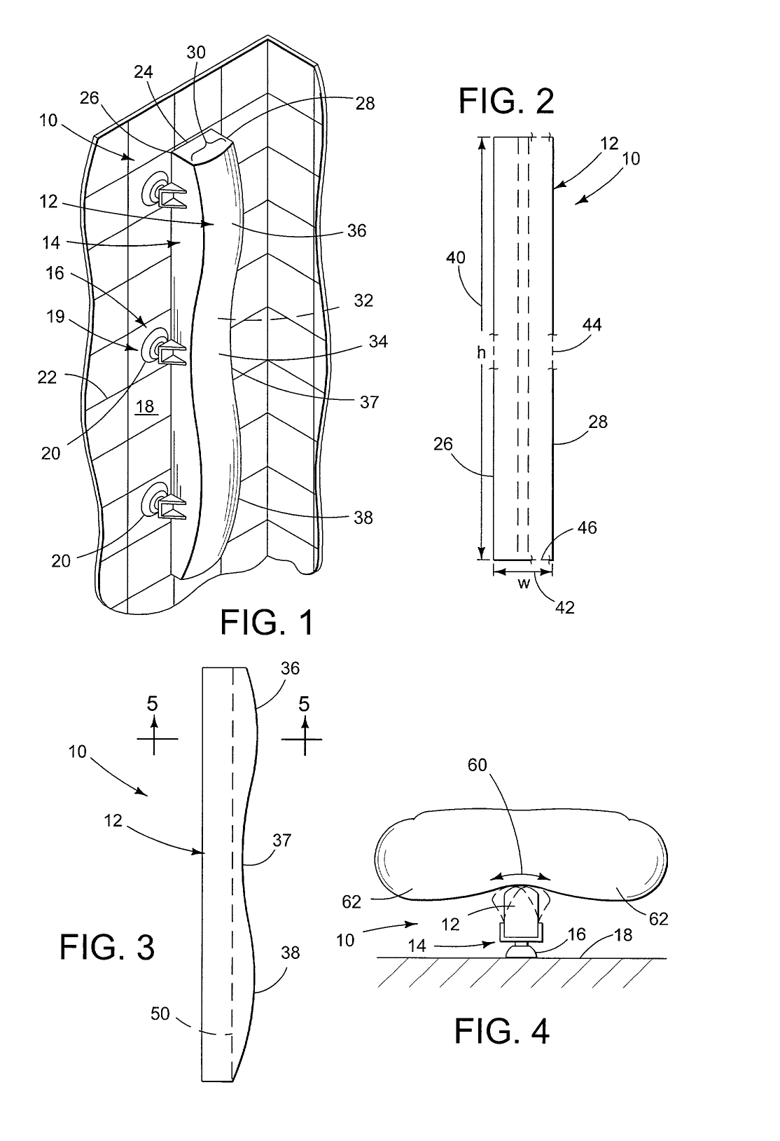

A back scratching device constructed according to the present invention is indicated generally at 10 in FIG. 1. Device 10 includes a body 12, a frame 14, and an attachment structure 16 that is adapted to mount the device on a wall, or wall surface, 18. For example, frame 14 may be adapted to be coupled to a shower wall via attachment structure 16. Use of the device in a shower enables a user to not only scratch their back, but also cleanse their back. However, it should be appreciated that device 10 may be used solely as a scratching device, and thus use on a surface other than a shower wall is within the scope of the invention.

It should be noted that the drawings depict a plurality of embodiments for device 10 and that like reference characters refer to corresponding elements throughout the multiple views. Similarly, the drawings illustrate exemplary embodiments that depict a variety of elements and subelements. It is within the scope of the invention that these elements and subelements may be selectively embodied in devices according to the present invention alone or in combination with one or more other elements and/or subelements, regardless of whether the particular selected element, subelement, or combination thereof is specifically illustrated in the figures. For example, any of the described and/or illustrated bodies may be used with any of the described and/or illustrated frames, and vice versa, regardless of the particular combination of frame and body that is shown in a specific figure.

Body 12 includes a core 32 and an abrasive contact surface 34. Core 32 provides a substantially rigid form upon which a user may press against. Contact surface 34 is the surface of core 32 that is adapted to engage a user's back to scratch and/or cleanse the user's back. Contact surface 34 may extend along the entire front face of body 12 or along portions thereof. Contact surface 34 also may extend at least partially around and along the sides of body 12. Contact surface 34 may be integral with core 32. Alternatively, contact surface 34 may be selectively removable from core 32, such that contact surface 34 may be selectively removed from the core, such as for cleaning or replacement.

During use, a user rubs against contact surface 34 to affect a scratching and cleansing action. The shape and size of body 12 affect the quality of any scratching and cleansing that occurs and/or the degree of movement required by a user to clean certain regions of a user's back. For example, in some embodiments of the invention, body 12 may have a curved longitudinal configuration that is adapted to at least generally conform to the shape of a user's back. An illustrative example of such a configuration is shown in FIG. 1. As shown, body 12 has an arcuate configuration that generally corresponds to the anatomical regions of a human spine. FIG. 3 is a side view of body 12 and further illustrates the contoured shape of body 12. The shape may follow the gentle curve of the spine or may exaggerate the curvature of the spine.

In the illustrated embodiment, body 12 has an undulating configuration that is shaped to generally conform to the cervical, thoracic and lumbar regions of the spine. For example, and as shown in FIGS. 1 and 3, body 12 includes a first convex region 36 transitioning into a depressed concave region 37, which transitions into a second convex region 38. Such a configuration enables a user to effectively scratch and/or cleanse all regions of a user's back. It is within the scope of the invention that body 12 may be shaped to at least generally conform to less than all three of these spinal regions, including a body that is shaped to simultaneously conform to two regions, or to conform to only a single region. In these alternative configurations, body 12 may, but does not necessarily, have a length that is shorter than, or even considerably shorter than, the length of most adult spines. It is also within the scope of the invention that body 12 may have a configuration that is not specifically shaped to conform to the shape of a human spine. An example of such a configuration is indicated at 50 in dashed lines in FIG. 3. The body may additionally or alternatively also be configured to conform to the shape of portions of a user's body, including a user's neck and/or torso.

It is also within the scope of the invention that the width of the body may be, but is not necessarily, shaped to generally conform to the shape of the human back or spine. Accordingly, body 12 may have a relatively narrow width that is sized to fit between an adult user's shoulder blades, and in some embodiments, to have a width that is approximately the width of an adult's spine. However, and similar to the above discussion regarding the length of body 12, the width of the body may vary within the scope of the invention and therefore should not be limited to widths that approximate the width of a human spine or the span between an adult's shoulder blades.

Illustrative dimensions for body 12 may be further appreciated with reference to FIG. 2. As shown, body 12 has both a vertical dimension 40 and a horizontal dimension 42. According to the present invention, body 12 may be elongate and sized to extend along at least a substantial portion of, or even the entire length of, a user's back or spinal cord. Body 12 may be further configured to be received and manipulated between a user's shoulder blades. In such a configuration, the vertical dimensions 40 of body 12 may exceed, or even substantially exceed, the horizontal dimensions 42 of body 12.

For example, in these embodiments the height of the device may be at least five times greater than the width. Thus, in such a configuration, the height to width aspect ratio is greater than, or equal to, five to one. As illustrated in FIG. 2, the height to width aspect ratio is approximately seven to one. Similarly, a height to width aspect ratio of eight to one, nine to one, ten to one, fifteen to one, twenty to one, thirty to one, etc., may enable a user to work device 10 effectively within the horizontal contours of the back, such as between the shoulder blades. However, both the vertical and horizontal dimensions may vary, as illustrated at 44 and 46, respectively, without departing from the scope of the invention. Thus, body 12 may be any suitable size that affords a user enough surface area to effectively scratch and/or cleanse the user's back.

Device 10 may be configured to maintain a relatively unyielding configuration during use. Alternatively, device 10 may be configured to move responsive to user-applied forces as a user rubs against contact surface 34. In other words, due to the construction of device 10, body 12 may flex as a user rubs against the device. For example, as shown in FIG. 4, body 12 may be pivotal about a long axis that is substantially parallel to the long axis of device 10. As a user draws their back across device 10, body 12 pivots as indicated by arrow 60 following the motion of the user's back. The device is thus manipulable between a user's shoulder blades 62 providing a massaging and scratching action against the user's back as it is rubbed against device 10.

In embodiments that are configured to provide this responsive motion, the attachment structure, frame and/or the body may be configured to enable this motion. For example, core 32 of body 12 may be formed from a deflectable, resilient material that enables the core to flex responsive to user-applied forces. Preferably, the core is further configured to automatically return to or toward its unbiased, or resting, position upon removal of the user-applied forces. Additionally or alternatively, frame 14 or attachment structure 16 may be configured to provide for deflection or pivoting of the body relative to the wall surface in response to user-applied forces, preferably with an automatic restoring motion upon removal of the user-applied forces.

The depth of device 10, namely, the distance that contact surface 34 projects away from wall surface 18, may vary from approximately an inch to several inches. In some embodiments, it may be desirable for device 10 to project at least 2-4 inches from the wall surface to provide sufficient clearance for a user to effectively use the device without having to contact the wall surface with the user's back. Such a construction also enables a user to rotate his/her back around the contact surface of body 12 without being hindered by the wall surface.

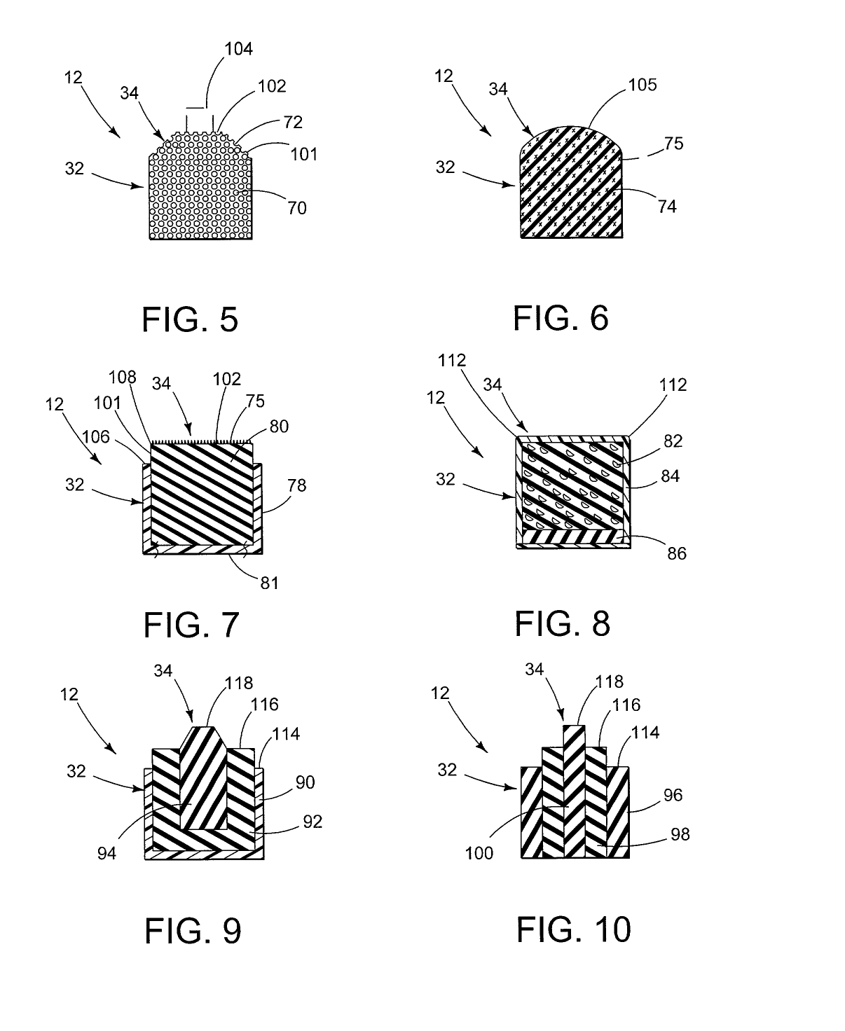

During use of device 10, a user engages contact surface 34 of body 12 and rubs against the contact surface. In FIGS. 5-10, further illustrative examples of the construction and shape of body 12 are shown. As discussed, it should be understood that body 12 includes a core 32 and a contact surface 34, which may be formed from the same or different materials and which may be permanently or releasably secured together. As used herein, “permanently secured” and “permanently coupled” are meant to refer to components that are adapted to be maintained together and are not specifically configured to permit repeated release and reattachment of the components. On the other hand, “releasably secured” and “releasably coupled” are meant to refer to components that are specifically adapted to be repeatedly released from and reattached into engagement with each other.

As further discussed, it should be understood that the illustrative configurations, materials and constructions may be implemented with any of the devices described and illustrated herein. For the purpose of brevity, the configurations depict various combinations of suitable shapes, constructions and materials. It should be understood that the selected combinations are provided for purposes of illustration and that it is within the scope of the invention that the described and/or illustrated configurations, materials and/or configurations may be used in other combinations. For example, a disclosed material of construction for core 32 may be used with cores having different shapes and/or different contact surfaces than the particular shape and/or contact surface with which the core material is illustrated and/or described herein without departing from the scope of the invention.

In embodiments of device 10 that are intended for use in showers or other wet environments, it may be desirable for device 10 to be at least substantially, if not completely, waterproof so that the device does not absorb water. Absorbed water may promote fungal growth, retain dirt or other residues, and also adds to the weight of the device. An example of a suitable waterproof material for core 32 is waterproof polymeric or plastic material, such as polyethylene, polyurethane, or neoprene. It should be understood that other foamable materials may be used as well. In fact, body 12 and frame 14 may both be formed from one or more densities of a foamable polymeric material. To reduce the weight of device 10, it may be preferable to use closed cell foamed material, such as closed-cell polyethylene. The closed-cell foam construction enables the core to be lightweight and at least substantially waterproof, as the closed-cells do not absorb water. It should be understood that the cells may retain a small amount of water, but this water is not absorbed into the device.

When a closed-cell foamed material 70 is used to form body 12, contact surface 34 may be formed by shearing or otherwise cutting core 32. Shearing core 32 results in a contact surface 34 comprised of a plurality of open, fragmented cells or microcups 72 on the surface of the core. The fragmented cells provide a rough surface that is suitable for scratching against. The abrasive quality of contact surface 34 enables a user to effectively scrub and exfoliate the skin on a user's back as it is drawn against contact surface 34. Furthermore, the fragmented cells do not absorb water, and consequently, minimize the likelihood of fungal growth along the surface of body 12.

Fungal growth may also be prevented by doping core 32. FIG. 6 provides an exemplary illustration of a core 32 that has been doped or impregnated with anti-microbial chemicals 74 to form an anti-microbial plastic core. Alternatively and/or additionally, abrasive materials may be incorporated within core 32. FIG. 6 also schematically illustrates that core 32 and/or contact surface 34 may include doped or impregnated abrasive materials 75. Materials 75 may be any suitable material that is safe for contact with a user's skin and which provides an abrasive surface against which the user's back may be rubbed for scratching and/or cleansing. Examples of suitable materials 75 include sand, metal or plastic particulate, and shell particles. It is within the scope of the invention that body 12 may also be at least partially formed from non-foamed materials, including non-cellular materials, such as metallic materials.

In FIGS. 5 and 6, body 12 is illustrated as being formed from a single material or generally homogenous mix of materials that are extruded, molded or otherwise formed as an integral structure. However, it is within the scope of the invention that body 12 may be formed from two or more discrete components that are secured together (permanently or releasably). For example, body 12 may include two or more layers of polyethylene or other suitable foamed or unfoamed plastic. Each of the layers of the core may have different densities to form a core having variable rigidity. An illustrative example of such a construction is shown in FIG. 7, in which body 12 is shown including at least two distinct layers. As shown, core 32 includes a base layer 78 and a central core layer 80 of a different (typically lower) density than the base layer. As shown, base layer 78 extends along both the sides and the back of layer 80. Rigid base layer 78 may extend upwards such that it forms at least a portion of contact surface 34. In such a configuration, a user may rub his/her back against both flexible central layer 80 and base layer 78, thereby providing a variable scratching surface. In the configuration shown in FIG. 7, contact surface 34 is at least substantially formed from layer 80. However, different proportions of contact surface 34 may be formed from base layer 78.

Alternatively, base layer 78 may extend completely around central core layer 80, and in such an embodiment, the contact surface is formed from or attached to layer 78. As another alternative, layer 78 may extend only on the backside of layer 80. In such an arrangement base layer 78 functions primarily as a base or structural frame 81 and not as part of contact surface 34. In such a configuration, contact surface 34 may be formed completely from layer 80, or may be applied to at least the portion of layer 80 that is distal base layer 78.

FIG. 8 illustrates another illustrative construction for the present invention. Specifically, body 12 is constructed from a material that may include an open-cell or water-absorbent material, which is schematically illustrated and indicated at 82. Material 82 may form the entire body 12, or only portions of the body. For example, it may be desirable for some regions of body 12 and/or contact surface 34 to be formed from a closed-cell or otherwise non-absorbent material and other regions to be formed from an absorbent material. When a non-absorbent contact surface is desired, material 82 may still be used; however, material 82 may be covered with a waterproof coating 84 to still provide an at least substantially, if not completely, waterproof body. FIG. 8 further illustrates a dual-density core, as shown by a base layer 86. Base layer 86 may be formed from an open-cell plastic or a closed-cell plastic. Thus, the core may be of a single material and/or multiple materials without departing from the scope of the invention.

More than two layers may be used in the construction of body 12. For example, FIG. 9 illustrates a body 12 having three layers of various densities and/or materials of construction. Specifically, body 12 includes a base layer 90, an intermediate layer 92 and a foamed core layer 94. Each of the layers may extend outward to contact surface 34 providing a variably yielding surface. In some embodiments, it may be desirable for layers 90-94 to be arranged in order of decreased or increasing density or rigidity; however, other configurations and arrangements may be used.

FIG. 10 illustrates another core construction that employs multiple layers. As illustrated, the layers are stepped to provide a contact surface 34 having regions with differing rigidity and/or density and/or materials of construction. The outside step 96 may be the most rigid or most dense, however, it is also possible that intermediate step 98 and/or inner step 100 is the most rigid or most dense. Thus, it should be understood that any combination and/or arrangement of layers of different densities are within the scope of the invention.

FIGS. 5-10 further illustrate various configurations for contact surface 34 of body 12. Specifically, contact surface 34 may be shaped or include surface structures that enhance the abrasive character of the contact surface. These surface structures may take the form of ridges, steps, grooves, channels, corners, shoulders, tracks, etc. These surface structures may be integrally formed with the body or may be selectively attached/detached to the body.

FIG. 5 shows a contact surface 34 having a central plateau, or ribbed, shape. Sides 101 extend inward and upward toward plateau or central contact ridge 102, creating a beveled region. The beveled regions may form a plurality of sloped contact regions. Sloped contact regions or sides 101 may extend at any angle to plateau 102 and body 12 and may provide additional surface area to surface 34. Plateau 102 may include a central ridge, shown in dashed lines at 104. These surface structures may enhance the abrasive action of the device and provide a more effective scratching device. Similarly, FIG. 6 shows body 12 having an arcuate or bowed surface 105, as measured transverse and/or parallel to the long axis of the body. Bowed surface 105 allows a user to more smoothly rotate their back across the contact surface because of the absence of projecting ridges, ribs or the like.

FIG. 7 shows another contact surface 34 for body 12 having sides 101 and plateau 102. Sides 101 extend perpendicular to plateau 102 and extend from lower ridges 106. Edges 108 are formed from the intersection of the sides 101 and plateau 102. Lower contact ridges 106 further provide an enhanced contact surface due to the increased density and rigidity of these ridges. A user rubs against lower ridges 106, edges 108 and plateau 102. It should be noted that sides 101 may extend at a variety of angles to plateau 102 and lower ridges 106. Sides 101 have been shown extending an exemplary distance above ridges 106, and it is within the scope of the invention that this distance may vary. FIG. 7 further illustrates that contact surface 34 may be formed by attaching an adhesive coating or structure to core 32 and/or by impregnating at least the portion of core 32 that extends generally away from attachment structure 16 with an abrasive material.

In FIG. 8, contact surface 34 is formed from the waterproof coating 84. The waterproof coating may include abrasive material, may be textured or otherwise treated to be abrasive, or may have an abrasive material or structure attached thereto. Alternatively, the waterproof coating may be applied to a contact surface having a plurality of ridges, which at least substantially form an abrasive contact surface. Thus, as shown in FIG. 8, contact ridges or edges 112, which are defined by the intersection of the sides of body 12 with the surface of body 12, may be described in some embodiments as providing an abrasive contact surface.

FIGS. 9 and 10 illustrate contact surfaces that include a variety of projecting regions and/or edges, as well as cores and contact regions that are formed from a plurality of layers of the same or differing materials. As shown, FIG. 9 includes a base layer 90 that creates a first contact ridge 114. Intermediate layer 92 forms a second contact ridge 116 and foamed core layer 94 forms a central contact ridge, or plateau, 118. Ridges 116 and 118 may extend generally parallel along the long axis of body 12. Similarly, FIG. 10 illustrates stepped layers forming a first contact ridge 114, a second contact ridge 116 and a central contact ridge 118. When the layers have different densities, the multiple ridges create a plurality of edges having variable relative degrees of hardness. Although only three ridges are illustrated, it should be understood that any number of ridges and/or densities are within the scope of the invention.

It should be further understood that numerous surface patterns or textures for surface 34 are possible and are within the scope of the invention. For example, contact surface 34 may include a plurality of multi-directional ridges or a saw tooth pattern. It may also be possible to provide a personalized surface pattern, such as one's name or other desired insignia. Furthermore, contact surface 34 may include papillae or other small projections jutting outwards from the surface. As another example, the surface may be dimpled or pocked.

As discussed, device 10 includes a frame 14. Frame 14 provides support to body 12. It is within the scope of the invention that frame 14 may be integrally formed with the body as a unitary structure, may be permanently coupled to the body, or may be releasably coupled to the body. Accordingly, frame 14 may form a region of the device that is generally distal to surface 34, or may be coupled to core 32 distal to surface 34, such as shown in FIG. 7 at 81. As another example, body 12 may include a sufficiently dense base material where the base material operates as the support surface or backing surface 24 of frame 14.

In some embodiments and as shown in FIG. 1, frame 14 may include a support, or backing, surface 24 and/or side panels, or sides, 26 and 28. Backing surface 24 typically will extend along at least portions of the vertical length of body 12. Alternatively, backing surface 24 may extend outwardly from body 12 at discrete points along the posterior of body 12 (not shown) and/or may include a plurality of spaced-apart segments. Likewise, any other suitable backing surface may be used without departing from the scope of the invention. Sides 26 and 28 provide horizontal rigidity to device 10. Sides 26 and 28 may project generally away from backing surface 24. Such a construction may form a slot 30 into which at least a portion of body 12 may extend.

Side panels 26 and 28 extend outward along the side of body 12 and may at least generally conform to the contours of body 12, as shown in FIG. 12. Side panels 26 and 28 may extend the same distance from surface 24 as body 12. Alternatively, side panels 26 and 28 are recessed below the sides of body 12. The distance that body 12 extends above sides 26 and 28 may vary, as illustrated at 124, in FIGS. 14, 15 and 16.

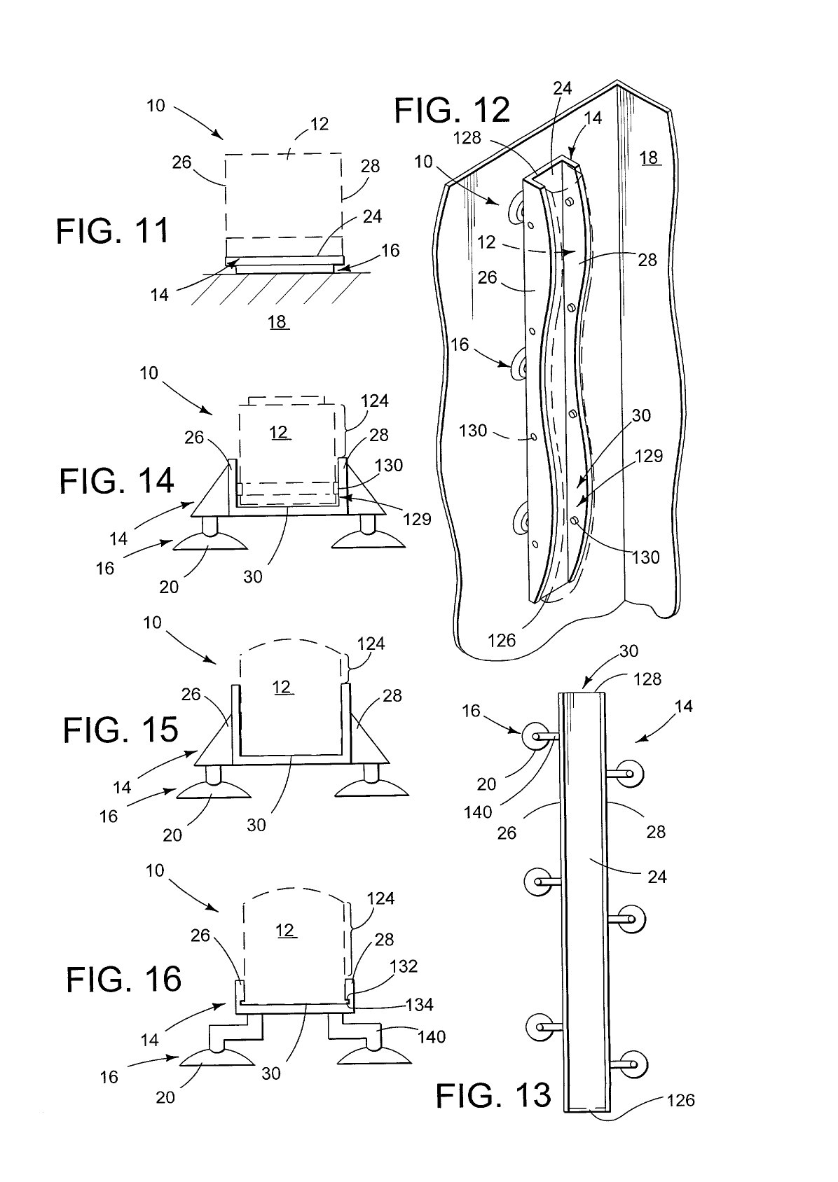

Additionally or alternatively, sides 26 and 28 may be incorporated at least partially within body 12. For example, body 12 may have a sufficiently rigid material defining the sides of body 12, thereby integrating the frame's side panels 26. In FIG. 11, an illustrative example of a back scratching device having a body 12 with a frame 14 whose side panels 26 and 28 are defined by the core's sides is shown. The frame's base, or backing surface, 24 may similarly be incorporated within body 12. Alternatively, a separate backing surface 24 may be attached to body 12 through any suitable attachment mechanism.

FIGS. 12 and 13 show another suitable configuration for frame 14. As shown, frame 14 defines a slot 30 into which body 12 at least partially extends. Body 12 may be selectively coupled to frame 14, such that the body is selectively removable from the frame. Such a configuration enables a user to remove body 12, such as for replacement or cleaning, from the frame without destroying the frame or body. Moreover, a user may initially select one type of body 12 having a particular surface configuration and/or density and later opt for another type of body having a different surface configuration and/or density. Similarly, multiple users may be able to utilize frame 14 by exchanging one body 12 for another body 12. Replacement of body 12 requires a user to simply release a first body 12 and insert a second body 12 into frame 14. It should be noted that body 12 may be symmetrical about its long axis, such that it is mountable within frame 14 with either of its generally opposed ends positioned toward the upper portion of frame 14.

When body 12 is adapted to be selectively removable relative to frame 14, the body may also be removed from the frame and thereafter used for cleaning or scratching while the body is removed from the frame. For example, a user may remove the body from the frame to cleanse and/or scratch other portions of the user's body. In such an embodiment, it may be desirable for body to be sufficiently flexible to enable the body to be bent around a user's limbs for cleaning and/or scratching. However, less flexible embodiments are also within the scope of the present invention.

In a further variation that is applicable to both selectively removable and permanently secured versions of the invention, body 12 and/or frame 14 may be adapted to be bent by a user to a desired configuration and to thereafter at least substantially retain that configuration until reshaped by a user. For example, a user may shape device 10 to conform to the configuration of the user's back or other desired shape.

Frame 14 may include end or bottom 126. As illustrated in FIG. 12, end 126 may be open, such as to allow water to drain from frame 14 and body 12. Alternatively, end 126 may be at least partially closed to prevent body 12 from sliding out of the bottom of frame 14, such as indicated in dashed lines in FIG. 13. Similarly, top 128 of frame 14 may be either open or closed depending on the configuration of frame 14. In embodiments of the invention in which the body is releasably coupled to the frame, the frame may include an open top 128 that permits sliding insertion and removal of the body into the slot.

In embodiments of the invention in which body 12 is releasably coupled to the frame, body 12 may be retained within frame 14 via any suitable mechanism, including, but not limited to, pins, stops, stays, detents, tongues-and-grooves, latches, braces, springs, etc. For example, frame 14 may include pins or other members that project at least partially into body 12 to retain body 12 in a desired position. Examples of such a configuration are shown in FIGS. 12 and 14, where body 12 is retained with slot 30 of frame 14 via projecting members 129 in the form of pins 130. Pins 130 may engage the outer sides of body 12 to frictionally retain the body in a selected position relative to the frame, or the pins may extend at least partially into a recess or channel in body 12.

As another example, the frame may include sides that are sized to frictionally engage the body without requiring the frame to include projecting members 129. Examples of such a construction are shown in FIGS. 13 and 15. As shown in FIG. 15, frame 14 includes sides 26, 28 and slot 30. Slot 30 is adapted to tightly accommodate body 12 in a manner that retains it within frame 14. Alternatively or additionally, and as shown in FIG. 16, slot 30 may include a groove 132 that generally corresponds to a projection 134 on body 12. Projection 134 slides within groove 132, thereby retaining body 12 within frame 14. As discussed, the particular dimensions and geometry of slot 30 may be defined at least in part by the size and shape of body 12 and/or the mechanism(s) by which body 12 is retained within slot 30.

In embodiments of device 10 in which the body is selectively coupled to the frame, the position of body 12 within frame 14 may be defined by such structure as the geometry of the body and/or frame, or by the fastening mechanism that is used to releasably couple the body to the frame. For example, frame 14 may include a slot with closed ends into which the body is shaped to be inserted such that the body completely fills the slot. As another example, the body may be releasably coupled to the frame by a fastening mechanism in which the body and the frame include mating members that couple the body and frame together when in engagement.

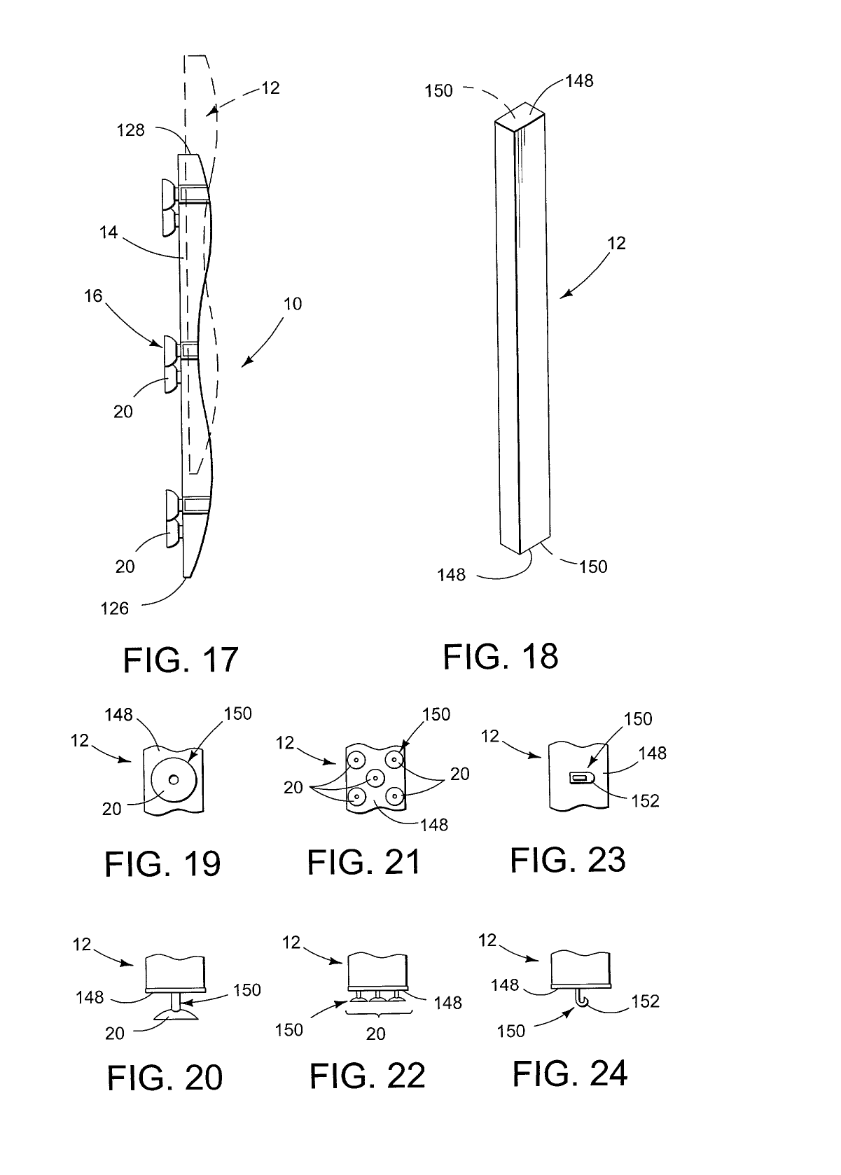

It is within the scope of the invention that the position of releasably coupled bodies may be selectively adjustable within a range of positions. For example, as shown in FIG. 17, body 12 is slidably adjustable within frame 14, such that body 12 may be repositioned within frame 14. Thus, a user may alter the position of body 12 within frame 14 to accommodate the user's height or preferred orientation for body 12. Similarly, devices 10 that include a body that is selectively positionable with respect to frame 14 enable the position of body 12 to be adjusted relative to wall surface 18 without requiring removal of the entire device from the wall surface. This feature may be particularly beneficial when the attachment structure is a permanent attachment structure or when the strength of the bond between the attachment structure increases with time. As discussed above, the position of body 12 may be maintained by any number of suitable mechanisms, including, but not limited, to pins, stops, stays, detents, latches, braces, springs, etc. Moreover, the top 128 and bottom 126 of such a frame may be open to enable body 12 to be slid into a position where the top or bottom of the body extends beyond the frame, such as indicated in dashed lines in FIG. 17.

As briefly discussed above, device 10 may be attached to a wall surface via attachment structure 16, which may also be referred to as a surface attachment structure. Attachment structure 16 may permanently couple or releasably couple the frame to wall surface 18. Accordingly, structure 16 may include any suitable fastening mechanism 19 for releasably securing or permanently securing the frame to a wall surface. Examples of fastening mechanisms that are adapted to releasably secure the frame to a wall surface include one or more suction cups or one or more releasable mechanical fasteners, such as screws. Examples of fastening mechanisms that are adapted to permanently secure the frame to a wall surface include an adhesive, as shown in FIG. 11.

Preferably, the suction cups or other fasteners are positioned so that they maintain a sufficient adhesive contact with the wall surface upon which they are secured to support device 10 on the surface. For example, conventional suction cups tend to bond reasonably well to tiles and other wall surfaces used in showers and bathrooms, but may form weaker bonds when in contact with grout lines, caulking, etc. Silicone suction cups overcome this problem. Another solution is to position the suction cups so that they do not contact grout/caulk lines and/or to provide a sufficient redundancy of suction cups or other fasteners such that a complete, or even partial, bond is not required from all of the fasteners.

As an illustrative example of a suitable fastening mechanism 19, FIG. 1 depicts surface attachment structure 16 including a fastening mechanism 19 in the form of a plurality of suction cups 20. Suction cups 20 may be spaced to straddle grout lines 22 on a tile shower wall. It should be understood that the fastening mechanism may vary within the scope of the invention and that such factors as the releasability of the attachment, the construction of the wall surface, the environment in which the device will be used, and user preferences may affect the particular fastening mechanisms used in a particular embodiment of the device.

Any number of suction cups may be used, and the size and relative positioning of the cups may vary within the scope of the invention. Thus, as illustrated in the associated drawings, multiple suction cups may be arranged in a single column, double columns, staggered columns, etc. Similarly, the suction cups may have any suitable construction, including single cups, double-coaxial cups, etc. Furthermore, a staggered arrangement of suction cups may provide better purchase against a shower wall and prevent the suction cups from being positioned on top of grout lines, tile joints, etc. By avoiding such junctures, the suction cups may more securely mount device 10 to a wall surface.

Suction cups 20 may extend directly from frame 14 and/or extend from extensions or feet that protrude from frame 14. Such a configuration of frame 14 with feet 140 is shown in FIGS. 13 and 16. As a further variation, the frame may include one or more mounts that extend at least partially within the body to couple the suction cups to the rest of the device.

Although device 10 may be used by a variety of individuals of differing sizes and abilities, one class of users are individuals that lack the flexibility to adequately scratch and/or cleanse their backs using manually positioned devices. Examples of these users include elderly and obese individuals. These and other individuals may similarly have difficulty picking objects up off of the floor of a shower. Accordingly, in some embodiments (as shown in FIG. 18), it may be desirable for body 12, and especially bodies that are releasably coupled to corresponding frames 14, to have at least one end 148 that includes a coupling structure 150. Coupling structure 150 is adapted to engage objects to be picked up and to create a sufficiently strong engagement with the objects so that a user may lift the objects using body 12. Examples of common objects to be picked up include bars of soap, wash cloths, and containers of shampoo. Examples of coupling structures 150 include suction cups and hooks.

It should be understood that the particular type and configuration of structures 150 will tend to vary depending upon the type and configuration of objects to be picked up. For example, suction cups may be effective at picking up bars of soap and some containers, but may not be effective at picking up wash cloths. Similarly, hooks may be effective at picking up wash cloths and some containers, such as containers with handles, necks or other portions around which the hook may extend to grasp the container, but hooks may not be effective at picking up bars of soap. Therefore, it is also within the scope of the invention that each end of body 12 may include a different type of coupling structure 150, as indicated in dashed lines in FIG. 18.

In FIGS. 19-22, examples of coupling structures 150 in the form of suction cups 20 are shown. In FIGS. 19 and 20, a single suction cup is shown, while in FIGS. 21 and 22, a plurality of suction cups are shown. A benefit of using more than one smaller suction cup is that the coupling structures may be able to form sufficiently strong bonds with objects to be picked up that a larger suction cup cannot. In FIGS. 23 and 24, an example of a coupling structure 150 in the form of a hook 152 is shown.

While various alternative embodiments and arrangements of a back scratching device have been shown and described above, it will be appreciated by those of skill in the art, that numerous other embodiments, arrangements and modifications are possible and are within the scope of the invention. For example, it should be noted that device 10 may include a plurality of other features and components. For example, frame 14 may include any number of structures typically found with shower devices, including, but not limited to, soap dispensers, hooks for washcloths, hanging racks for sponges and other bath devices.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein. Where claims recite “a” or “a first” element or equivalent thereof, such claims should be understood to include incorporation of one or more such elements, neither requiring, nor excluding, two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of those claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A back scratching device, comprising:
a body having a closed-cell at least partially foamed plastic core and an abrasive contact surface, wherein the abrasive contact surface is at least substantially defined by a plurality of fragmented cells;
a frame adapted to provide support to the body; and
a surface attachment structure coupled to the frame and adapted to mount the device on a wall surface.

2. The device of claim 1, wherein the body is shaped to at least generally correspond to the cervical, thoracic and lumbar regions of a spine.

3. The device of claim 1, wherein the body is adapted to be releasably coupled to the frame so that the body may be repeatedly removed from and reattached to the frame.

4. The device of claim 1, wherein the body is slidably adjustable relative to the frame.

5. The device of claim 1, wherein the body is integral with the frame.

6. The device of claim 1, wherein the frame includes a base and side panels, wherein the base and side panels define a slot into which the body at least partially extends.

7. The device of claim 1, wherein the body is selectively positionable within a range of positions within the slot.

8. The device of claim 7, wherein the device includes a fastening mechanism adapted to selectively retain the body in a selected position within the range of positions within the slot.

9. The device of claim 1, wherein the abrasive contact surface includes a plurality of contact ridges that extend generally parallel to the long axis of the core.

10. The device of claim 1, wherein the abrasive contact surface includes a stepped region forming a plurality of angular edges projecting generally away from the surface attachment structure.

11. The device of claim 1, wherein the abrasive contact surface includes a beveled region such that the surface includes a plurality of sloped contact regions.

12. The device of claim 1, wherein the abrasive contact surface includes an impregnated abrasive material.

13. The device of claim 1, wherein the core includes a first layer of a first density of a foamable material and a second layer of a second density of a foamable material that is different than the first density.

14. The device of claim 13, wherein the first layer extends outward to the abrasive contact surface to form a first step and the second layer extends outward to the abrasive contact surface to form a second step.

15. The device of claim 13, wherein the first layer at least substantially forms the contact surface.

16. The device of claim 13, wherein the contact surface is completely formed by the first layer.

17. The device of claim 13, wherein the first layer forms a base layer and the first density is greater than the second density.

18. The device of claim 1, wherein the body includes a horizontal dimension and a vertical dimension, and further wherein the vertical dimension of the body substantially exceeds the horizontal dimension of the body.

19. The device of claim 1, wherein the body has a height and a width, wherein the height is at least five times greater than the width.

20. The device of claim 19, wherein the body is shaped to at least generally correspond to at least two of the cervical, thoracic and lumbar regions of a spine.

21. The device of claim 20, wherein the body is shaped to at least generally correspond to the cervical, thoracic and lumbar regions of a spine.

22. The device of claim 1, wherein the body has a height and a width, wherein the height is at least ten times greater than the width.

23. The device of claim 1, wherein the surface attachment structure includes an adhesive.

24. The device of claim 1, wherein the body is at least substantially formed from polyethylene.

25. The device of claim 24, wherein the body and the frame are at least substantially formed from polyethylene, and optionally include a plurality of different regions of polyethylene having different densities.

26. The device of claim 24, wherein at least a portion of the body is impregnated with an abrasive material.

27. The device of claim 1, wherein the body is impregnated with antimicrobial chemicals.

28. The device of claim 11, wherein the body is adapted to have an unbiased position in which the device is free from user applied-forces, and further wherein the body is adapted to pivot away from the unbiased position responsive to user-applied forces to the contact surface.

29. The device of claim 28, wherein the body is further adapted to automatically return toward the unbiased position upon removal of the user-applied forces.

30. A back scratching device, comprising:
a body with a height and a width, the body having a core, which is at least partially formed from a foamed material, and an abrasive contact surface, wherein the body includes a horizontal dimension and a vertical dimension that substantially exceeds the horizontal dimension;
a frame adapted to provide support to the body; and
a surface attachment structure coupled to the frame and adapted to mount the frame on a wall surface.

31. The device of claim 30, wherein the body has a height to width aspect ratio greater than or equal to five to one.

32. The device of claim 30, wherein the body has a height to width aspect ratio of greater than or equal to eight to one.

33. The device of claim 30, wherein the body is arcuately shaped to at least generally correspond to at least two of the cervical, thoracic and lumbar regions of a spine.

34. The device of claim 30, wherein the body is shaped to at least generally correspond to the cervical, thoracic and lumbar regions of a spine.

35. The device of claim 30, wherein the body is adapted to be releasably coupled to the frame such that the body may be repeatedly removed from and reattached to the frame.

36. The device of claim 30, wherein the body is slidably adjustable relative to the frame.

37. The device of claim 36, wherein the frame defines a slot into which the body at least partially extends and within which the body is selectively positionable within a range of positions.

38. The device of claim 37, wherein device includes a fastening mechanism adapted to selectively retain the body in a selected position within the range of positions within the slot.

39. The device of claim 30, wherein the body is integral with the frame.

40. The device of claim 30, wherein the body is at least substantially formed from a closed-cell foamed material.

41. The device of claim 30, wherein the abrasive contact surface includes a plurality of fragmented cells.

42. The device of claim 30, wherein the contact surface includes a plurality of contact ridges extending generally parallel to the long axis of the core.

43. The device of claim 30, wherein the core includes a first layer of a first density of a foamable material and a second layer of a second density of a foamable material that is different than the first density.

44. The device of claim 43, wherein the first layer extends outward to the abrasive contact surface to form a first step and the second layer extends outward to the abrasive contact surface to form a second step.

45. The device of claim 30, wherein the contact surface is adapted not to absorb water.

46. The device of claim 30, wherein the body is adapted to not absorb water.

47. A back scratching device, comprising:
a body having a closed-cell foam plastic core and an abrasive contact surface formed from a plurality of layers that includes at least a first layer having a first density and at least a second layer having a second density that is different than the first density;
a frame adapted to provide support to the body; and
a surface attachment structure coupled to the frame and adapted to mount the device on a wall surface.

48. The device of claim 47, wherein at least of portion of the foam plastic core is impregnated with anti-microbial chemicals.

49. The device of claim 47, wherein at least one of the plurality of layers is foamed polyethylene.

50. The device of claim 47, wherein at least one of the plurality of layers is substantially rigid.

51. The device of claim 47, wherein the body is adapted to have an unbiased position in which the device is free from user-applied forces, and further wherein the body is adapted to pivot away from the unbiased position responsive to user-applied forces to the contact surface.

52. The device of claim 51, wherein the body is further adapted to automatically return toward the unbiased position upon removal of the user-applied forces.

53. The device of claim 51, wherein the body includes a long axis and the body is adapted to pivot away from the unbiased position about an axis that extends generally parallel to the long axis.

54. The device of claim 47, wherein the body is adapted to be releasably coupled to the frame to permit the body to be repeatedly removed from and reattached to the frame.

55. The device of claim 47, wherein the body is integral with the frame.

56. The device of claim 47, wherein at least one of the plurality of layers is substantially formed from fragmented cells.

57. The device of claim 47, wherein the body is slidably adjustable relative to the frame.

58. The device of claim 47, wherein the body is arcuately shaped to at least generally correspond to the cervical, thoracic and lumbar regions of a spine.

59. A method of making a scratching device, comprising:
providing a closed-cell foam body;
shearing a surface of the body to form an abrasive contact surface with a plurality of fragmentary cells; and
attaching the body to a frame assembly including a frame and a surface attachment structure adapted to mount the device on a wall surface.

60. The method of claim 59, further comprising shaping the body to generally correspond to a user's spine.

61. The method of claim 59, further comprising providing a frame having a slot adapted to receive the body.
